(19) United States
(12) Patent Application Publication
(10) Pub. No.: US 2005/0136706 A1
(43) Pub. Date: Jun. 23, 2005

(54) Steerable body board

(76) Inventor: Tzong In Yeh, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/012,093

(22) Filed: Dec. 16, 2004

(30) Foreign Application Priority Data
Dec. 19, 2003 (TW) 092222362

(51) Int. Cl. H01R 12/00

(52) U.S. Cl. 439/74

(57) ABSTRACT

A steerable body board is provided that can be easily and safely to be manipulated to change the moving directions of the steerable body board and can be safely slow down or stopped. The steerable body board contains a board body, a bottom plate and a control unit. The board body has a channel therethrough. The bottom plate is installed next to a bottom surface of the board body and overlays an end of the channel. The bottom plate has plural parallel ribs on a bottom surface of the bottom plate. The control unit is connected to the bottom plate through the channel for steering the bottom plate.

### TECHNICAL FIELD

This invention relates generally to a body board, in particular, to provide a steerable body board.

### BACKGROUND OF THE INVENTION

Body boards are used to slide on snow, grass or sand. A traditional body board mainly contains a board body and plural holders installed thereon. Using the body board, a user lies prostrate on the board body and holds on the holders. To change the directions of the body board when the body board is sliding, the user needs to shift his position of center of gravity. To slow down or stop the movements of the body board, the user needs to use his feet to press against the ground to provide a friction therebetween. However, the speed of the body board sometimes becomes very fast when sliding down from a slope and to change directions of the body board by shifting the position of gravity requires high skills and experiences. Frequently, a user cannot properly control the moving directions of the body board by shifting his position of center of gravity and collides with another body board user. In addition, a user is likely to get hurt when using his feet to press against the ground to slow down or stop the body board if the speed of the body board is very fast or there are some obstacles such as stones on the ground covered by snow or sand. In view of these problems, a steerable body board that is easily and safely to be manipulated to change the moving directions of the body board and to slow down or stop the movements of the body board is needed.

### SUMMARY OF INVENTION

Therefore, the primary objective of the present invention is to provide a steerable body board that can be easily and safely to be manipulated to change the moving directions of the steerable body board.

Another object of the invention is to provide a steerable body board that can be safely slow down or stopped.

The present invention, briefly summarized, in one embodiment discloses a steerable body board. The steerable body board contains a board body, a bottom plate and a control unit. The board body has a channel therethrough. The bottom plate is installed next to a bottom surface of the board body or in a circular recession in the body board's bottom surface. The bottom plate overlays an end of the channel. The bottom plate has plural parallel ribs on a bottom surface of the bottom plate. The control unit is connected to the bottom plate through the channel for steering the bottom plate.

### BRIEF DESCRIPTION OF DRAWINGS

The invention will be more clearly understood after referring to the following detailed description read in conjunction with the drawings wherein:

FIG. 1 is an prospective view of the first embodiment of the present invention;

FIG. 2 is an exploded prospective view of the first embodiment;

FIG. 3 is another exploded prospective view of the first embodiment;

FIG. 4 is a cross sectional view of the first embodiment;

FIG. 5 is an exploded prospective view of a second embodiment; and

FIG. 6 is a cress sectional view of the second embodiment.

### DETAILED DESCRIPTION OF PREFERRED EMBODIMENTS

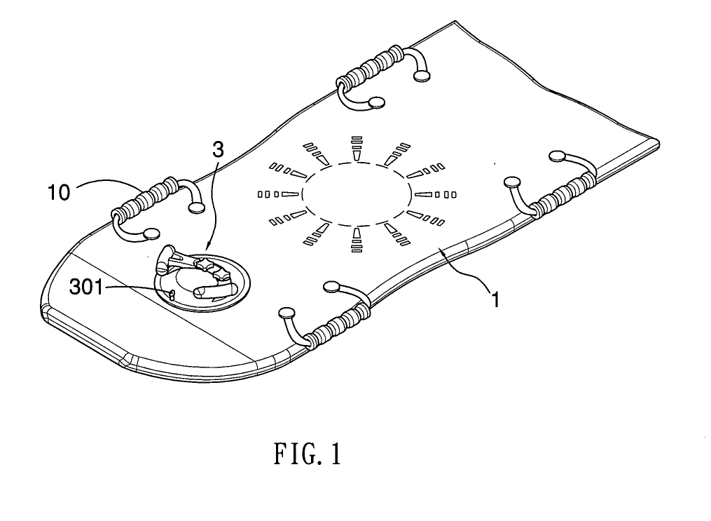

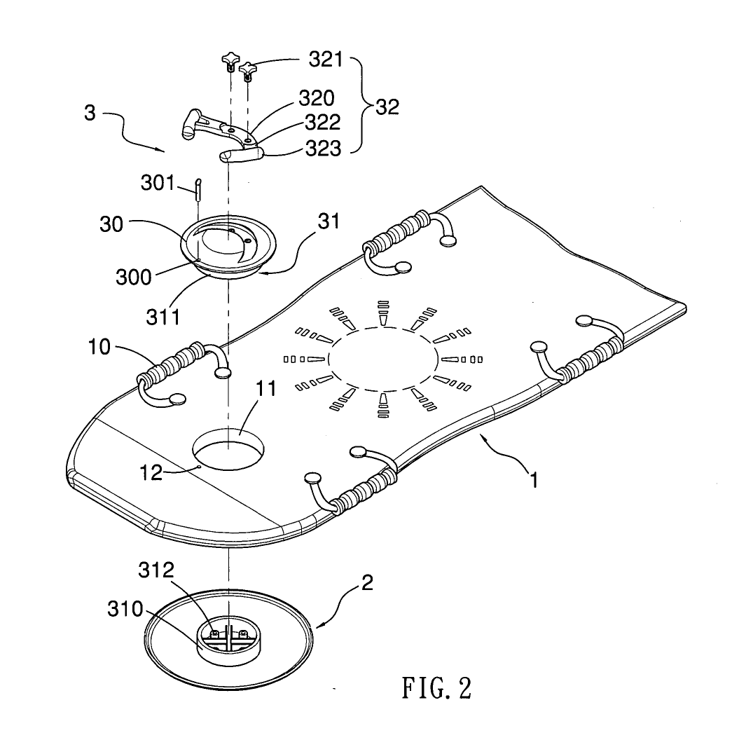

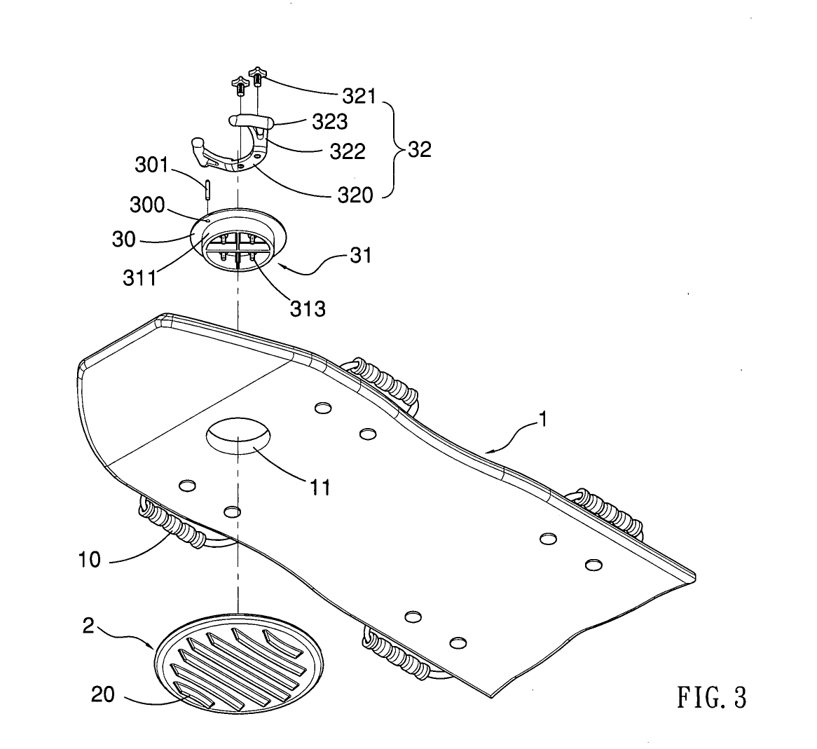

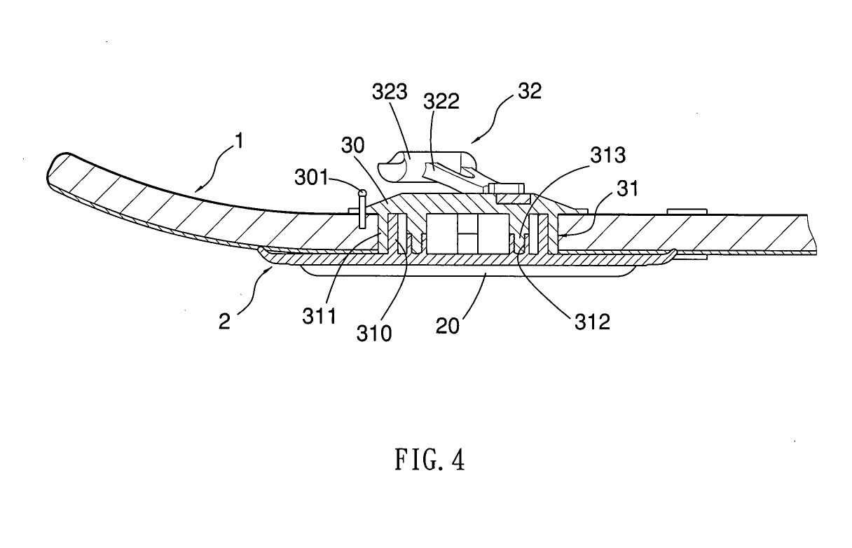

With reference to FIG. 1 to FIG. 4, an first embodiment of the present invention contains a board body 1, a bottom plate 2 and a control unit 3. The board body 1 has a channel 11 therethrough. The board body 1 is made of a polyethylene foam board.

The top surface and edge surfaces of the board body 1 are covered by a composite plastic film having a pattern printed therein. Thereby, the composite plastic film can protect the pattern from wear and tear. The bottom surface of the board body 1 is united with a plastic plate. Plural holders 10 are installed on a top surface of the board body 1 for being held by users to prevent the users from being bumped out of the board body 1. A positioning hole 12 is installed close to an edge of the channel 11.

The bottom plate 2 is installed next to a bottom surface of the board body 1 and overlays an end of the channel 11. The bottom plate 2 has plural parallel ribs 20 on a bottom surface of the bottom plate 2. The plural parallel ribs 20 are for controlling the moving directions of the steerable body board. The control unit 3 is connected to the bottom plate 2 through the channel 11 for steering the bottom plate 2. The control unit 3 contains a shaft 31, a top plate 30, and a steering device 32. The shaft 31 is mounted on a top surface of the bottom plate 2. The shaft 31 is rotatable within the channel 11. The top plate 30 is installed next to a top surface of the board body 1 and connected to the shaft 31. The steering device 32 is mounted on a top surface of the top plate 30. The top plate 30 has a through hole 300 penetrating therethrough and aligned with the positioning hole 12 in the board body 1. A plug 301 is pluggable through the through hole 300 and the positioning hole 12 to fix the top plate 30 to the board body 1.

The shaft 31 contains a hollow cylinder 310, and a sleeve 311. The hollow cylinder 310 is mounted on the top surface of the bottom plate 2. The hollow cylinder 310 has plural snapping pipes 312 mounted therein. The sleeve 311 is mounted on a bottom surface of the top plate 30. The sleeve 311 has plural snapping protrusions 313 mounted therein for being engaged with the snapping pipes 312. The hollow cylinder 310 is engagable with the sleeve 311. When the sleeve 311 is engaged with the hollow cylinder 310 by embracing the hollow cylinder 310, the plural snapping protrusions 313 are inserted into the snapping pipes 312 respectively.

The steering device 32 contains a base 320, at least a fastener 321, two handles 323 and two frames 322. The at least a fastener 321 is for fastening the base 320 to the top plate 30.The two handles 323 are located at both sides of the base 320 for being held by users to steer the embodiment. The two frames 322 connect the two handles 323 to the base 320 respectively at both sides of the base 320.

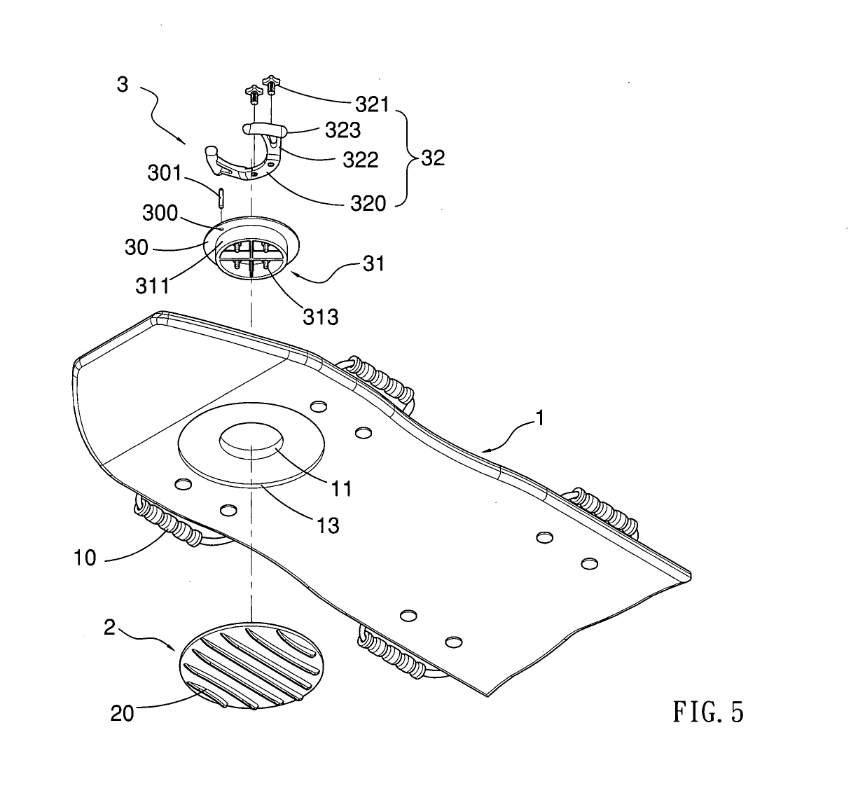

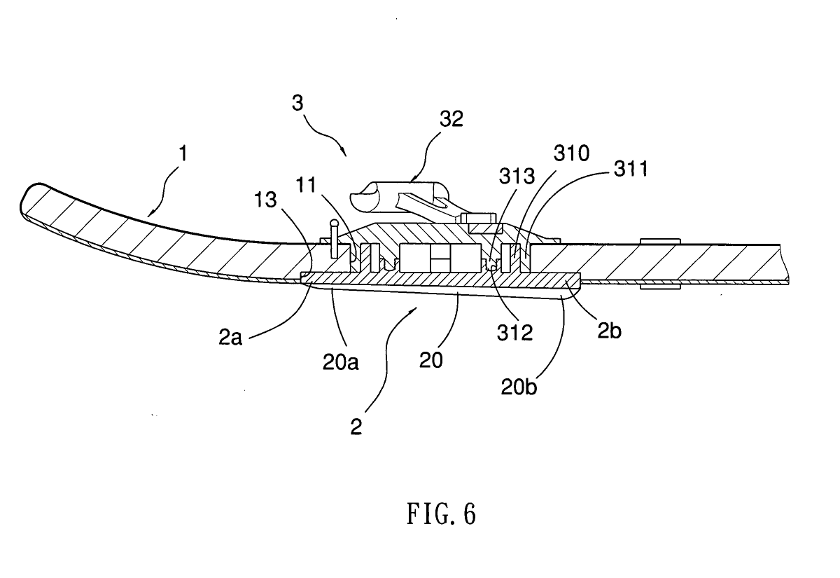

With reference to FIG. 5 and FIG. 6, a second embodiment of the present invention mainly contains: a board body 1, a bottom plate 2 and a control unit 3. The board body 1 has a channel 11 therethrough and a circular recession 13 in a bottom surface thereof. The circular recession 13 is coaxial to the channel 11. The bottom plate 2 is installed in the circular recession 13 and overlaying an end of the channel 11. The bottom plate 2 has plural parallel ribs 20 on a bottom surface of the bottom plate 2. The control unit 3 is connected to the bottom plate 2 through the channel 11 for steering the bottom plate 2.

The bottom plate 2 has a front portion 2a having a bottom surface aligned with the bottom surface of the body board 1, and a rear portion 2b having a bottom surface exposed 1-2 mm beyond the bottom surface of the body board 1. Each of the parallel ribs 20 has a front portion 20a and a rear portion 20b wherein the front portion 20a having a height smaller than a height of the rear portion 20b. The second embodiment contains plural holders 10 on a top surface of the board body 1 for being held by users.

The control unit 3 mainly contains a shaft 31, a top plate 30 and a steering device 32. The shaft 31 is mounted on a top surface of the bottom plate 2. The shaft 31 is rotatable within the channel 11. The top plate 30 is installed next to a top surface of the board body 2 and connected to the shaft 31. The steering device 32 is mounted on a top surface of the top plate 30.

The shaft 31 contains a hollow cylinder 310 mounted on the top surface of the bottom plate 2. The hollow cylinder 310 has plural snapping pipes 312 mounted therein and a sleeve 311 mounted on a bottom surface of the top plate 30. The sleeve 311 has plural snapping protrusions 313 mounted therein for being engaged with the plural snapping pipes 312. In addition, the steering device 32 contains a base 320, at least a fastener 321 for fastening the base 320 to the top plate 30, two handles 323 located at both sides of the base 320 for being held by users and two frames 322 connecting the two handles 323 to the base 320 respectively. Furthermore, the second embodiment further contains a positioning hole 12 installed in the board body 1, a through hole 300 penetrating the top plate 30 and a plug 301 pluggable through the through hole 300 and the positioning hole 12 for preventing the bottom plate 2 from rotating.

In a third embodiment of the invention (not shown), the steerable body board has the same elements and structures of the first embodiment except the shaft 31. In this embodiment, the shaft 31 contains a cylinder mounted on a bottom surface of the top plate 30. The cylinder is engagable to a top surface of the bottom plate 2 through the channel 11.

In a fourth embodiment of the invention (not shown), the steerable body board has the same elements and structures of the first embodiment except the shaft 31. In this embodiment, the shaft 31 contains a cylinder mounted on a top surface of the bottom plate 2. The cylinder is engagable to a bottom surface of the top plate 30 through the channel 11.

In a practice of the invention, a user takes off the plug 301 from the positioning hole 12 and the through hole 300 of the top plate 30. The user uses his hands to hold on the handles 323 of the steering device 32 to control the moving directions of the steerable body board. Since the top plate 30 is mounted to the shaft 31 at one end and the bottom plate 2 is mounted to the shaft 31 at the other end of the shaft 31, the bottom plate 2 moves synchronously with the top plate 30. When the user rotates the top plate 30 to the right direction by operating the handles 323 of the steering device 32, the plural parallel ribs 20 on the bottom plate 2 moves to the right direction. In that way, the left sides of the parallel ribs 20 undertake the friction against the ground and turn the moving direction of the steerable body board to the right direction. Similarly, when the user rotates the top plate 30 to the left direction, the steerable body board moves to the left direction.

In another practice of the invention, a user rotates the handles 323 of the steering device 32 to make the plural parallel ribs 20 perpendicular to the moving direction of the steerable body board, the contact surfaces between the plural parallel ribs 20 and the ground maximizes, and the friction therebetween also maximizes. Thereby, the speed of the steerable body board can be reduced and finally come to a stop.

In further practice of the invention, a user inserts the plug 301 into the through hole 300 and the position hole 12 to fix the top plate 30 to the board body 1. Since the bottom plate 2 is mounted to an end of the shaft 31 and the top plate 30 is mounted to the other end of the shaft 31, when the top plate 30 is fixed, the parallel ribs 20 on the bottom plate 2 is also fixed. Therefore the moving direction of the steerable body board is fixed.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extent indicated by the broad general meaning of the terms in which the appended claims are expressed.

1. A steerable body board comprising:
a board body having a channel therethrough;
a bottom plate installed next to a bottom surface of said board body and overlaying an end of said channel, said bottom plate having plural parallel ribs on a bottom surface of said bottom plate; and
a control unit connected to said bottom plate through said channel for steering said bottom plate.

2. The steerable body board of claim 1, further comprising plural holders on a top surface of said board body for being held by users.

3. The steerable body board of claim 1, wherein said control unit comprises:
a shaft mounted on a top surface of said bottom plate, said shaft being rotatable within said channel;
a top plate installed next to a top surface of said board body and connected to said shaft; and
a steering device mounted on a top surface of said top plate.

4. The steerable body board of claim 3, wherein said shaft comprises:
a hollow cylinder mounted on said top surface of said bottom plate, said hollow cylinder having plural snapping pipes mounted therein; and
a sleeve mounted on a bottom surface of said top plate, said sleeve having plural snapping protrusions mounted therein for being engaged with said plural snapping pipes;
wherein said hollow cylinder is engagable with said sleeve.

5. The steerable body board of claim 3, wherein said steering device comprises:
a base;
at least a fastener for fastening said base to said top plate;
two handles located at both sides of said base for being held by users; and
two frames connecting said two handles to said base respectively.

6. The steerable body board of claim 3, further comprising:
a positioning hole installed in said board body;
a through hole penetrating said top plate; and
a plug pluggable through said through hole and said positioning hole for preventing said bottom plate from rotating.

7. A steerable body board comprising:
a board body having a channel therethrough, said board body having a circular recession in a bottom surface thereof, said circular recession being coaxial to said channel;
a bottom plate installed in said circular recession and overlaying an end of said channel, said bottom plate having plural parallel ribs on a bottom surface of said bottom plate; and
a control unit connected to said bottom plate through said channel for steering said bottom plate.

8. The steerable body board of claim 7, wherein said bottom plate has a front portion having a bottom surface aligned with said bottom surface of said board body, and a rear portion having a bottom surface exposed 1-2 mm beyond said bottom surface of said board body.

9. The steerable body board of claim 8, wherein each of said parallel ribs has a front portion and a rear portion, said front portion of said plural parallel ribs having a height smaller than a height of said rear portion of said plural parallel ribs.

10. The steerable body board of claim 9, further comprising plural holders on a top surface of said board body for being held by users.

11. The steerable body board of claim 10, wherein said control unit comprises:
a shaft mounted on a top surface of said bottom plate, said shaft being rotatable within said channel;
a top plate installed next to a top surface of said board body and connected to said shaft; and
a steering device mounted on a top surface of said top plate.

12. The steerable body board of claim 11, wherein said shaft comprises:
a hollow cylinder mounted on said top surface of said bottom plate, said hollow cylinder having plural snapping pipes mounted therein; and
a sleeve mounted on a bottom surface of said top plate, said sleeve having plural snapping protrusions mounted therein for being engaged with said plural snapping pipes.

13. The steerable body board of claim 12, wherein said steering device comprises:
a base;
at least a fastener for fastening said base to said top plate;
two handles located at both sides of said base for being held by users; and
two frames connecting said two handles to said base respectively.

14. The steerable body board of claim 13, further comprising:
a positioning hole installed in said board body;
a through hole penetrating said top plate; and
a plug pluggable through said through hole and said positioning hole for preventing said bottom plate from rotating.
